(19) United States
(12) Patent Application Publication
(10) Pub. No.: US 2013/0118230 A1
(43) Pub. Date: May 16, 2013

(54) Clocked Blowing Away of a Contaminated Gas Cloud

(71) Applicant: Krones AG, Neutraubling (DE)

(72) Inventors: Bernhard Dunzinger, Unterdeggenbach (DE); Hans-Jurgen Straubinger, Grasslfing (DE); Karl Aichinger, Metten (DE)

(73) Assignee: Krones AG, Neutraubling (DE)

(21) Appl. No.: 13/676,894

(22) Filed: Nov. 14, 2012

(30) Foreign Application Priority Data
Nov. 15, 2011 (DE) 102011086381.8

(51) Int. Cl. G01N 30/00

(52) U.S. Cl. CPC G01N 30/00
USPC 73/23.35; 73/31.05; 422/52

(57) ABSTRACT

The disclosure relates generally to a method for testing containers for foreign substances, wherein a standard gas is blown into a container to be tested, at least a part of the test gas escaping from the container is tested by a measuring device, and the part of the test gas remaining outside the measuring device is removed from the measuring area in a clocked manner, e.g. by blowing it away or sucking it off.

### FIELD OF THE INVENTION

The invention relates to a method and an apparatus for testing containers for impurities/foreign substances and foreign gases. A foreign gas in this context also includes the components mixed with a gas or smells of foreign substances, such as foreign liquids and/or foreign solids.

### BACKGROUND

If containers are used for the first time, and in particular if containers are reused, it is necessary to test the containers for impurities or a contamination before they are cleaned or filled in order to remove possibly contaminated containers from the production process and/or decontaminate them.

A method is known, for instance, from DE 44 27 314 A1, wherein a standard gas is blown into the container through the container opening, thereby expelling a possible foreign gas contained in the container and carrying off the mixture of standard gas and foreign gas, referred to as test gas below, to a measuring device. However, the foreign gas or test gas, respectively, is not removed entirely, i.e. a part of the foreign/test gas remains outside the measuring device, and a stationary contamination cloud may be formed in the measuring/container treatment area, which may lead to an incorrect measurement result of subsequent containers, e.g. by so-called memory effects caused by accretions of the contamination on the measuring device. Also, subsequent containers may be contaminated by said contaminated gas cloud.

A method is known from U.S. Pat. No. 6,013,228, wherein a ventilator continuously generates an airflow in the direction of the movement of the conveyed containers so as to blow contaminated gas clouds out of the measuring area.

However, such a method has the drawback that, if the blowing is continuous, only a weak blowing pressure can be generated as the containers could otherwise be blown away or damaged. Also, it may be possible that material or dust on containers is dispersed, thereby clogging or interfering with measuring sensors. In addition, a continuous blowing away may reduce the concentration of possible foreign substances in the test gas during the withdrawal/tests to such an extent that a detection of existing foreign substances is difficult or cannot be carried out at all.

The present disclosure is therefore based on the objective to provide a method and an apparatus for the improved testing of containers for impurities/foreign substances or foreign gases, such as petrol, oil residues, undesired flavors etc.

### SUMMARY

According to some aspects of the present disclosure, this is achieved by a method according to claim 1 and an apparatus according to claim 8. Advantageous embodiments and further developments are defined in the dependent claims. Additional optional features and advantages may include any one or more of the following.

Accordingly, it is possible that after blowing a standard gas into a container to be tested, e.g. a bottle, and measuring at least a part of the test gas escaping from the container, a part of the test gas remaining outside the measuring device can be removed from the measuring area in a clocked manner, e.g. by blowing it away or sucking it off.

The possibility of a complete or adaptive clocking has the advantage that, for instance under a high pressure, e.g. of more than 50, 100 kPa, a stationary contaminated gas cloud or the part remaining outside the measuring device can be blown out of the measuring area, for instance, if no container is located in the measuring area.

The possibility of blowing away at a high pressure allows a fast (within a period of less than, for instance, 10, 20 ms) removal of the contaminated gas clouds nearly without test gas residues. The reduced decontamination time allows a higher container throughput frequency, and thus an enhanced production efficiency. At the same time, it can be avoided that containers to be tested are blown away or damaged or that material is whirled up from the container which may contaminate or affect the measuring device.

Furthermore, the detection of foreign substances in the test gas can be facilitated because it is possible not to blow away/suck off gas or air in the measuring area during the test gas sampling, thereby avoiding that the concentration of possible foreign substances in the test gas is diluted.

Also, it is conceivable that a blowing away/sucking off is carried out only if a contamination of the tested container was detected. This has the advantage that energy and air can be saved as the blowing away/sucking off is carried out to a smaller extent as compared to blowing away/sucking off after each container measurement.

Advantageously, the test gas, or the part of the test gas withdrawn for the measurement, can be tested by the measuring device mass-spectrometrically. On the other hand, also other chromatographic testing methods and measuring devices are feasible, including, for instance, chemiluminescence analyzers, photoionization detectors or fluorescence gas analyzers.

The standard gas to be introduced into the container to be tested may be, for instance, air, an inert gas, e.g. nitrogen, a noble gas (mixture) or a combination of these gases.

For blowing away the part of the test gas remaining outside the measuring device, for instance, ambient air, technically purified air/ambient air or a standard gas may be used.

According to some aspects of the disclosure, an apparatus for testing containers for foreign substances includes a measuring device, at least one injection unit, at least one blowing-away unit and/or sucking-off unit, and at least one sampler. The at least one injection unit is configured to be capable of blowing a standard gas into a container to be tested, and the at least one sampler is configured to be capable of sampling at least a part of the test gas escaping from the container to be tested and passing it on to the measuring device, and the at least one blowing-way unit and/or sucking-off unit is configured to be capable of blowing away/sucking off a part of the test gas remaining outside the measuring device from the measuring area in a clocked manner.

### BRIEF DESCRIPTION OF THE DRAWINGS

The figures show by way of examples:

FIG. 1a, 1b: exemplary operating schemes of an apparatus for testing containers for foreign substances.

FIG. 2a, 2b: an apparatus for testing containers for foreign substances.

FIG. 3: a top view of an apparatus for testing containers for foreign substances.

FIG. 4: a top view of an alternative apparatus for testing containers for foreign substances.

### DETAILED DESCRIPTION

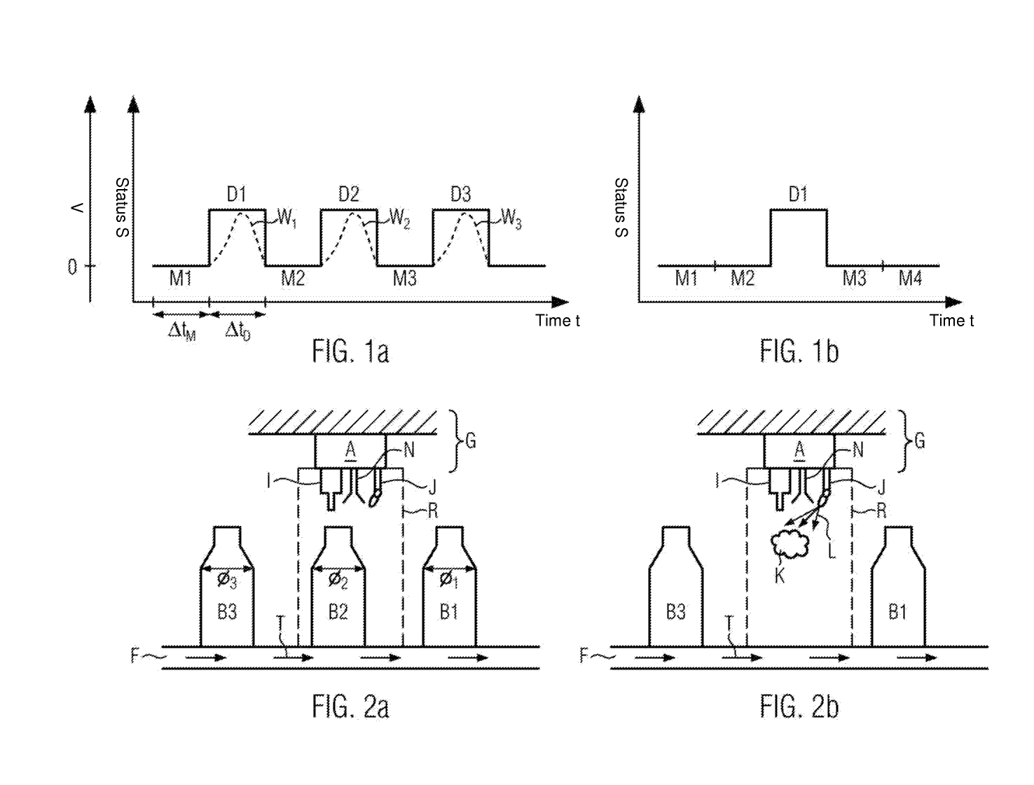

FIG. 1a schematically shows an exemplary operating scheme of an apparatus for testing containers for foreign substances. In the figure the status S of the apparatus for testing containers for foreign substances is represented on a first axis of ordinates over the time. Accordingly, the measuring area is, for instance after each measurement M1, M2, M3 etc. lasting ΔtM1, ΔtM2, ΔtM3, decontaminated for a period of ΔtD1, ΔtD2, ΔtD3 of the method step D1, D2, D3 of testing containers for foreign substances.

Decontamination is to imply, for instance, the status of the apparatus or the method step when the blowing-away/sucking-off unit carries off the part of the test gas remaining outside the measuring device, e.g. by blowing it away and/or sucking it off, while no standard gas injection or measurement is carried out, i.e. the injection unit does not blow in a standard gas and the sampler does not take a sample. In turn, measurement/testing for foreign substances refers to the status of the apparatus or the method step when the blowing-away unit/sucking-off unit does not generate an airflow/gas flow, the injection unit injects a standard gas into a container, the sampler samples a part of the test gas escaping from the container and passes it on to a measuring device, the measuring device carries out a measurement and provides a measurement result.

In this example a uniform clock between the decontamination and the measurement is shown, in which each measurement and decontamination take the same time. Of course, both the clock and the periods of measurement/decontamination may vary. In particular the period of decontamination may take more time or less time than the period of measurement.

The transition time between the measurement and the decontamination has been neglected in the representation, as it is assumed by way of example that the transition time between a measurement and a decontamination is short as compared to the measurement and the decontamination, i.e. is quasi instantaneous.

FIG. 1a additionally shows a second axis of ordinates v, which may be interpreted as the rate at which the part of the test gas remaining outside the measuring device is blown away/sucked off. For instance, if a ventilator is used it may be that a certain starting time is necessary to reach a desired blowing-away rate, and that a certain coast-down time is necessary until the ventilator has come to a standstill. Thus, this example shows a wave-type curve W1, W2, W3 etc. of the blowing-away rate. If the blowing-away device is, for instance, a nozzle or another gas outlet opening, which may be controlled by valves, quasi instantaneous blowing-away rate changes can be achieved, however. A valve-controlled nozzle implies, for instance, that a nozzle is associated with a valve that regulates the airflow/gas flow of the nozzle. Also, the end of a pipe or a gas outlet opening/gas inlet opening may be valve-controlled, i.e. have an associated valve regulating the gas outflow and gas inflow.

FIG. 1b exemplarily shows an alternative operating scheme of an apparatus for testing containers for foreign substances. Like in FIG. 1a, the status S of the apparatus for testing containers for foreign substances is represented over time. In this example, the clock of decontamination or, respectively, blowing away/sucking off the part of the test gas remaining outside the measuring device is irregular, i.e. a decontamination is carried out only if a contamination was detected, e.g. by measurement M2.

If a clocking is used at which a decontamination is carried out only if no container is located in the measuring area it is possible to carry off the part of the test gas remaining outside the measuring device at high rates and high pressures, e.g. more than 50, 100 kPa.

FIG. 2a exemplarily shows an apparatus G for testing containers for foreign substances. The apparatus G comprises, for instance, an injection unit I, e.g. an injection nozzle, by means of which a standard gas can be introduced into a container to be tested, and a sampler N capable of sampling at least a part of the test gas escaping from the container to be tested and passing it on to a measuring device A. The apparatus G also includes a blowing-away/sucking-off unit J, e.g. a valve-controlled nozzle which may be located in the proximity of the sampler, e.g. at a minimum distance of at least 0.5, 1.0, 5.0 or 10.0 cm and a maximum distance of less than 10.5, 15.0, 20.0, 30.0 cm. Also, it is possible that the blowing-away/sucking-off unit J is located at another place of the apparatus, preferably inside the measuring area R, however, which may be defined by a spatial volume with dimensions in terms of height, depth and width within a range of 10, 20, 30 or 50 cm.

The blowing-away/sucking-off unit J may also comprise, for instance, a joint by means of which the direction of the blowing-away flow/sucking-off flow can be adjusted. Furthermore, it is shown that a container B2 is provided in the measuring area and together with other containers can successively run through the apparatus G on a conveyor belt F, i.e. the apparatus is capable of treating and testing both moved containers and stationary containers.

FIG. 2b shows the apparatus G of FIG. 2a after container B2 was tested and has moved out of the measuring area R. The empty measuring area R, in particular in the proximity of the sampler, can be decontaminated by the blowing-away/sucking-off unit J, for instance, by the blowing-away/sucking-off unit J producing a lateral and/or vertical airflow L which is capable of carrying off a part K of the test gas remaining outside the measuring device from the measuring area. The lateral component of the airflow/gas flow of the blowing-away/sucking-off unit J may be oriented such that the lateral component of the airflow/gas flow is perpendicular, i.e. at a non-zero angle (preferably 70° to 110°), to a provided/preconfigured introduction/transport direction of the containers into the/to the/out of the apparatus G for testing containers for foreign substances. For instance, the containers can be conveyed on a conveyor belt.

Also, the blowing-away/sucking-off unit J may simply be a pipe end. Preferably the blowing-away/sucking-off unit J is a nozzle, however, which is, for instance, equipped with valves for being capable of generating a quasi instantaneous airflow at a high pressure (e.g. >50, 100 kPa), this pressure being applied upstream of the valve or, if the valve is opened, upstream of a possible nozzle.

Moreover, it is conceivable that the removal of the part K of the test gas remaining outside the measuring device from the measuring area R is additionally supported by an outlet/a suction channel and/or an air conduction element. Thus, it is possible that blowing away and sucking off may be carried out at the same time. To this end, for instance, the blowing-away/sucking-off unit J may simultaneously have a blowing-away device, e.g. a blowing-away nozzle, and a sucking-off device, e.g. a pipe end. Of course, it is also conceivable that the apparatus G for testing containers for foreign substances can comprise at least one outlet/one suction channel and/or one air conduction element in addition to and/or separated from the blowing-away/sucking-off unit J in order to be capable of carrying off/sucking off a part of the test gas remaining outside the measuring device from the measuring area.

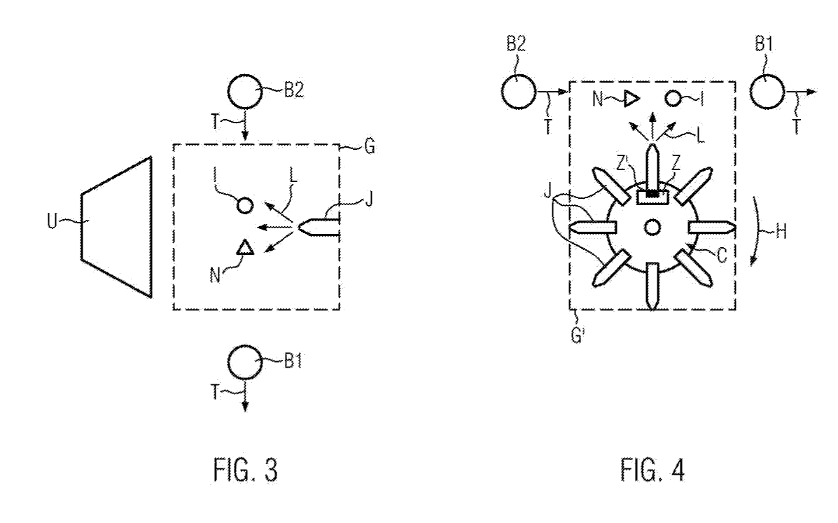

FIG. 3 shows by way of example a top view of an apparatus G for testing containers for foreign substances. It exemplarily shows a moment of the decontamination, at which the blowing-away/sucking-off unit J produces an airflow L perpendicular to the provided direction of movement/transport of the containers B1 and B2 in the direction of the sampler N and the injection unit I so as to blow away the part of the test gas remaining outside the measuring device. FIG. 3 also shows by way of example an additional component part U, which may be an outlet/a suction channel and/or an air conduction element capable of sucking off and/or carrying off the part of the test gas remaining outside the measuring device. For the sake of clarity the measuring device A, which belongs to the apparatus G for testing containers for foreign substances, as well as the part K of the test gas remaining outside the measuring device are not illustrated in FIG. 3.

FIG. 4 shows by way of example a top view of an alternative apparatus G′ for testing containers for foreign substances. The alternative apparatus G′ may include at least one mobile platform C, e.g. in the form of a wheel, which may rotate, for instance, in a sense of rotation H and/or may move in translation relative to the transport direction T of the containers in a synchronously or asynchronously controlled manner, and may comprise at least one, preferably a plurality of blowing-away/sucking-off units J, e.g. in the form of blowing pipes/suction pipes. The at least one blowing-off/sucking-off unit J/the blowing-off/sucking-off units J is/are served by an air distributor Z which, if the blowing-away/sucking-off unit(s) J is/are provided upstream of the air distributor slot Z′, blows gas/air into the blowing-away/sucking-off unit(s) J and/or sucks it off so that the part of the test gas remaining outside the measuring device can be blown away/sucked off.

The platform C can move synchronously with the movement of the containers in the direction of transport T so as to allow a clocked blowing away/sucking off. The platform may be controlled in such a way that the active blowing-away/sucking-off unit J, i.e. a blowing-away/sucking-off unit J provided upstream of the air distributor slot Z′, sweeps/travels through the measuring area upstream of a new container to be tested, whereby a blowing-away/suction flow L can be produced which moves along with a propagation component provided in parallel with the container transport direction.

This has the advantage that contaminations between the containers can be expelled from the measuring area for a longer period, as compared to using a stationary blowing-away/sucking-off unit J or stationary blowing-away/sucking-off units.

Like in FIG. 3, FIG. 4 exemplarily shows a moment of decontamination, at which a blowing-away/sucking-off unit J located on a star wheel produces an airflow L perpendicular to the provided direction of movement/transport of the containers B1 and B2 in the direction of the sampler N and the injection unit I so as to blow away the part of the test gas remaining outside the measuring device.

For the sake of clarity the measuring device A′, which belongs to the apparatus G′ for testing containers for foreign substances, as well as the part K of the test gas remaining outside the measuring device are not illustrated in FIG. 4 either.

Attached are two sheets with five figures, the reference numbers designating:
v rate of the blowing-away/sucking-off flow
D1, D2, D3, . . . first decontamination, second decontamination, third decontamination, etc.
S status of the apparatus for testing containers for foreign substances
M1, M2, M3, . . . first measurement/test for foreign substances, second measurement/test for foreign substances, third measurement/test for foreign substances, etc.
ΔtM1, ΔtM2, ΔtM3, . . . duration of the first, second, third, . . . etc. measurement/test for foreign substances
ΔtD1, ΔtD2, ΔtD3, . . . duration of the first, second, third, . . . etc. decontamination W1, W2, W3, . . . blowing-away/sucking-off rate curve
t time
B1, B2, B3, etc. container 1, container 2, container 3 etc.
Ø1, Ø2, Ø3, etc. diameters of B1, B2, B3 etc. at the widest point thereof
G, G′ apparatus for testing containers for foreign substances
A measuring device
I injection unit, e.g. an injection nozzle by means of which a standard gas can be introduced into a container to be tested
N sampler
J blowing-away/sucking-off unit(s)
R measuring area
L airflow/gas flow
K part of the test gas remaining outside the measuring device
F conveyor/conveyor belt for conveying containers
T provided direction of transport of the containers into the/to the/out of the apparatus
G for testing containers for foreign substances
U component part, which may be an outlet/a suction channel and/or an air conduction element
C platform
H sense of rotation
Z air distributor
Z′ air distributor slot

1. A method for testing containers for foreign substances, the method comprising that a standard gas is blown into a container to be tested, that at least a part of the test gas escaping from the container is tested by a measuring device, and that the part of the test gas remaining outside the measuring device is removed from the measuring area in a clocked manner.

2. A method according to claim 1, the method comprising that the part of the test gas remaining outside the measuring device is blown away from the measuring area in a clocked manner under a high pressure if the tested container (B) is no longer located in the measuring area (R).

3. A method according to claim 1, wherein the part of the test gas remaining outside the measuring device is blown away and/or sucked off from the measuring area in a clocked manner only if a contamination of the tested container was detected.

4. A method according to claim 1, wherein at least a part of the test gas escaping from the container is tested by a measuring device chromatographically.

5. A method according to claim 1, wherein the blown-away part of the test gas remaining outside the measuring device is conducted to an outlet and/or is sucked off.

6. A method according to claim 1, wherein the standard gas comprises air, an inert gas, a noble gas, a noble gas mixture, or a combination of the aforementioned gases.

7. A method according to claim 1, wherein the part of the test gas remaining outside the measuring device is blown away with ambient air or technically purified air/ambient air or standard gas.

8. An apparatus for testing containers for foreign substances, comprising a measuring device, at least one injection unit, at least one blowing-away unit and/or sucking-off unit, and at least one sampler, configured such that the at least one injection unit is capable of blowing a standard gas into a container to be tested, and the at least one sampler is capable of sampling at least a part of the test gas escaping from a container to be tested and passing it on to the measuring device, wherein the at least one blowing-away unit and/or sucking-off unit is capable of blowing away/sucking off a part of the test gas remaining outside the measuring device from the measuring area in a clocked manner.

9. An apparatus according to claim 8, wherein the at least one blowing-away unit and/or sucking-off unit comprises at least one of a ventilator, a pipe end, a valve-controlled pipe end, a nozzle, and a valve-controlled nozzle.

10. An apparatus according to claim 8, wherein the at least one blowing-away unit and/or sucking-off unit has a minimum distance from the sampler between about 0.5 cm and about 10.0 cm, and a maximum distance from the sampler between about 10.5 cm and about 30.0 cm.

11. An apparatus according to claim 8, wherein the at least one blowing-away unit and/or sucking-off unit is configured in such a way that a part of a test gas remaining outside the measuring device can be blown away/sucked off from the measuring area in a clocked manner only if no container to be tested is located underneath the sampler in the measuring area.

12. An apparatus according to claim 8, wherein the at least one blowing-away unit and/or sucking-off unit is configured in such a way that a part of a test gas remaining outside the measuring device can be blown away/sucked off from the measuring area in a clocked manner only if a contamination in the test gas is detected.

13. An apparatus according to claim 8, wherein the measuring device, comprises at least one of a mass spectrometer, a chemiluminescence analyzer, a photoionization detector, and a fluorescence gas analyzer.

14. An apparatus according to claim 8, wherein the at least one blowing-away unit and/or sucking-off unit is capable of producing a lateral and/or vertical airflow/gas flow, wherein the lateral component of the airflow/gas flow of the blowing-away/sucking-off unit may be oriented such that the lateral component of the airflow/gas flow is perpendicular to a provided/preconfigured introduction/transport direction of the containers into and/or out of the apparatus for testing containers for foreign substances.

15. An apparatus according to claim 8, wherein the apparatus additionally comprises at least one outlet, suction channel, and/or air conduction element and is capable of carrying off/sucking off a part of the test gas remaining outside the measuring device from the measuring area.

16. An apparatus according to claim 8, wherein the apparatus additionally comprises at least one mobile platform which can rotate and/or can move in translation relative to the transport direction of the containers in a synchronously or asynchronously controlled manner, and has one or more blowing-away/sucking-off units and the mobile platform has at least one air distributor having at least one air distributor slot, and the one or more blowing-away/sucking-off unit(s) can be served by an air distributor which, if the blowing-away/sucking-off unit(s) is/are provided upstream of an air distributor slot, is capable of blowing in a clocked manner gas into and/or sucking off in a clocked manner gas from the blowing-away/sucking-off unit(s) so that the part of the test gas remaining outside the measuring device can be blown away/sucked off in a clocked manner.

17. A method according to claim 1, wherein the step of removing the part of the test gas remaining outside the measuring device comprises blowing the remaining test gas away or sucking the remaining test gas off.

18. A method according to claim 2, wherein the high pressure is more than 50, 100 kPa.

19. A method according to claim 1, wherein the part of the test gas remaining outside the measuring device is blown away and/or sucked off after each test by the measuring device, and no blowing and/or sucking off takes place during the test by the measuring device .

20. A method according to claim 4, wherein the measuring device tests mass-spectrometrically.

21. An apparatus according to claim 15, wherein the mobile platform is in the form of a wheel.

22. An apparatus according to claim 15, wherein the blowing away/sucking-off units are in the form of blowing pipes/suction pipes.
